(19) United States
(12) Patent Application Publication
(10) Pub. No.: US 2024/0168743 A1
(43) Pub. Date: May 23, 2024

(54) IDENTIFYING DEPLOYED SOFTWARE PACKAGES IN STATELESS CONTAINERS

(71) Applicant: Capital One Services, LLC, McLean, VA (US)

(72) Inventors: Tao XU, Clarksburg, MD (US); Joseph Robert Sacchini, Reston, VA (US); Sateesh MAMIDALA, Glen Allen, VA (US); Nesreen MANSOUR, Great Falls, VA (US)

(73) Assignee: Capital One Services, LLC, McLean, VA (US)

(21) Appl. No.: 17/988,875

(22) Filed: Nov. 17, 2022

(51) Int. Cl. G06F 8/61; H04L 9/32

(52) U.S. Cl. CPC G06F 8/63; H04L 9/3236

(57) ABSTRACT

Disclosed herein are system, method, and computer program product embodiments for identifying deployed software packages. In some embodiments, a server receives a request to identify a variance between a current list of deployed software packages stored in a database and software packages associated with a docker image. The current list of deployed software packages indicates a respective layer and a respective docker image of each software package in the list. Furthermore, the server identifies a first layer of the one or more layers that is absent from the database and downloads the first layer. The server unpacks the first layer to identify a first set of software packages from the plurality of software packages corresponding to the first layer and updates the current list of deployed software packages to include the first set of software packages.

### BACKGROUND

Enterprises often deploy numerous software packages across distributed systems. The software packages may be updated based on newer versions of a given software package or replaced over time. To this end, the enterprise may need to maintain a running list of deployed software packages for reasons such as asset management, security, compliance monitoring, etc. Conventional systems initially deploy a container image comprising deployed software packages to identify the deployed software packages. However, this is a time-consuming and operationally expensive process.

### BRIEF DESCRIPTION OF THE DRAWINGS

The accompanying drawings are incorporated herein and form a part of the specification.

FIG. 1 is a block diagram of an architecture of a system for identifying deployed software packages, according to some embodiments.

FIG. 2 is a block diagram illustrating an example data flow of the system for identifying deployed software packages, according to some embodiments.

FIG. 3 illustrates an example docker image, according to some embodiments.

FIG. 4 is a flowchart illustrating the process for identifying the deployed software packages in a distributed system, according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method, and/or computer program product embodiments, and/or combinations and sub-combinations thereof for identifying deployed software packages.

As described above, conventional systems have to download a container image and deploy the software packages in the container image to identify the deployed software packages. To this end, conventional systems oftentimes inadvertently download duplicate container images when attempting to identify the deployed software packages. Furthermore, downloading the container image and extracting the software packages from the container image requires running a host machine. An agent would be installed on the host machine to collect the image software list. In light of this, conventionally, identifying deployed software packages is an operationally expensive and error-prone process.

Embodiments described herein solve these problems by identifying deployed software packages from a stateless docker image. In some embodiments, a server receives a request to identify a variance between a current list of deployed software packages stored in a database and software packages associated with a docker image. The current list of deployed software packages indicates a respective layer and a respective docker image of each software package in the list. The server identifies one or more layers of the docker image based on metadata of the docker image. Furthermore, the server identifies a first layer of the one or more layers that is absent from the database and downloads the first layer. The server unpacks the first layer to identify a first set of software packages from the plurality of software packages corresponding to the first layer and updates the current list of deployed software packages to include the first set of software packages.

The embodiments described herein provide for keeping track of the currently deployed software packages without downloading or deploying a container image corresponding to a docker image. This avoids inadvertently downloading duplicate copies of layers of the docker image or running a host machine with an agent to identify the deployed software packages in a container image. Moreover, by keeping track of the currently deployed software packages, the embodiments described herein allow for compliance monitoring, asset management, security monitoring, etc.

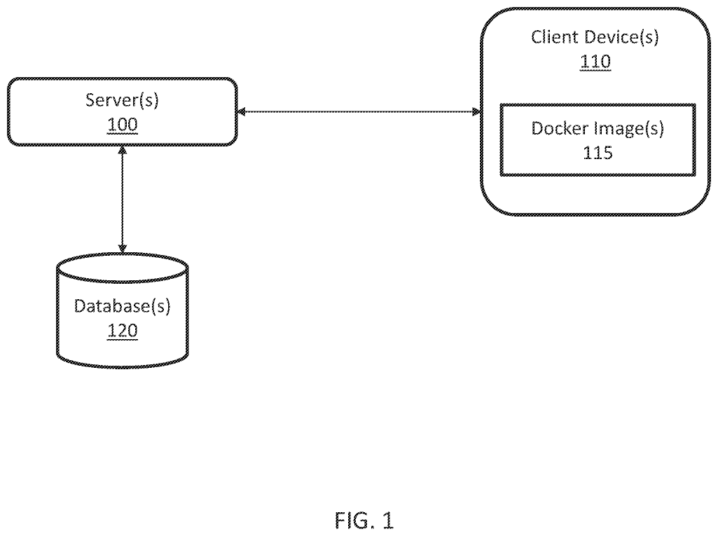

FIG. 1 is a block diagram of an architecture of a system for identifying deployed software packages, according to some embodiments. In an embodiment, the architecture may include server(s) 100, client device(s) 110, and database(s) 120. The devices in the architecture can be connected through wired connections, wireless connections, or a combination of wired and wireless connections.

As an example, the devices can be connected through a network. The network can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

Client device 110 may be configured to deploy container images in a distributed system. Container images may include one or more software packages executed on the distributed system. Each software package may be a new software package or an update of an existing software package in the distrusted system.

Client device 110 may comprise docker image(s) 115. Docker image 115 may comprise instructions for creating a container image. Docker image 115 may comprise one or more layers. Each layer may correspond with a group of instructions. For example, docker image 115 may comprise a first layer corresponding to instructions associated with a run command, a second layer corresponding to instructions associated with a copy command, and a third layer corresponding to instructions associated with an add command.

Each layer of docker image 115 may list or indicate one or more of the software packets deployed or to be deployed on the distributed computing system. Each layer may include a respective group of instructions for the one or more software packages indicated or listed in the respective layer.

In some embodiments, docker image 115 may be made up of a bundle of files. The bundle of files may include installations, application code, and dependencies. The bundle of files may be used to configure a fully operational container environment. Each of the files may be a layer of docker image 115, and each layer may depend on a subsequent layer.

Database 120 may be one or more data storage devices configured to store structured or unstructured data. Database 120 may store lists of software packages deployed on the distributed computing system. Database 120 may correlate each software package with a given docker image 115 and the respective layer of the software package. The list of software packages may comprise an identifier of the deployed software package, version of the software package, and respective layer.

As a non-limiting example, a container image may comprise one or more software packages. The software packages may be part of an enterprise system for a corporation, such as a financial institution and/or the like.

Server 100 may be one or more servers or computing devices operating inside or outside a cloud computing environment. Server 100 may completely or partially reside in a cloud-computing environment. In some embodiments, server 100 may be a web server. Server 100 may be configured to track the deployed software packages on the distributed computing system.

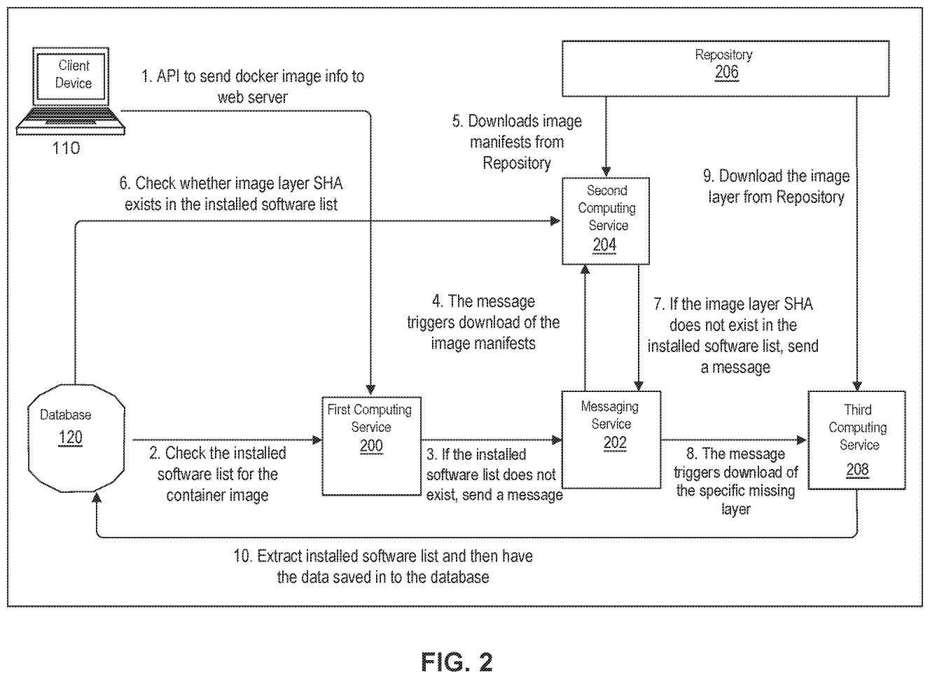

Tracking of deployed software packages will be described in greater detail with respect to FIG. 2.

FIG. 2 is a block diagram illustrating an example data flow of the system for identifying deployed software packages, according to some embodiments. FIG. 2 shall be described with reference to FIG. 1. However, the example data flow of FIG. 2 is not limited to the aspects of FIG. 1. The example data flow described in FIG. 2 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

In some embodiments, in step 1, an Application Program Interface (API) executing on client device 110 may transmit an alert that software packages have been deployed on a distributed system. The alert may comprise docker image 115 to a first computing service 200. Docker image 115 may be a bundle of files comprising layers and instructions for generating a container. Each layer may include instructions associated with one or more software packages to be deployed or already deployed on a distributed system.

First computing service 200 may be part of server 100. First computing service 200 may be a serverless compute service. Furthermore, first computing service 200 may be an event-driven compute service. That is, first computing service 200 may be triggered to execute based on an event. An event may be receiving docker image 115 from the API.

In step 2, first computing service 200 may query database 120 to determine whether the software packages in docker image 115 exist in database 120. Docker image 115 may include a list of software packages. As such, first computing service 200 may query database 120 to compare the list of software packages with the software packages included in database 120. First computing service 200 may compare an identifier of the software in the list of software packages to the identifiers of the software packages in database 120.

In step 3, if there is a difference between the list of software packages and the software packages included in databases 120, first computing service 200 transmits a message to a messaging service 202. Messaging service 202 may be configured to receive, queue, and forward messages between computing services. Messaging service 202 may be part of server 100.

In step 4, messaging service 202 forwards the message to second computing service 204. Second computing service 204 may be part of server 100. Second computing service 204 may be a serverless compute service. Furthermore, second computing service 204 may be an event-driven compute service.

In step 5, the message may trigger second computing service 204 to download docker image 115's manifest from repository 206. Repository 206 may be a repository manager that is configured to store docker image 115's manifest. Repository 206 may also store the layers of docker image 115.

Docker image 115's manifest may include a description of the image. The description of the image may be in a structured format including, but not limited to, JavaScript Object Notation (JSON) format, YAML format, Protobuf format, MongoDB format, and/or the like. The manifest may include image tags, a digital signature, details on how to configure the container, and/or the like. The manifest may also include a list of docker image 115's layers and their order. The list of docker image 115's layers may include the hash identifier of each layer of docker image 115. As a non-limiting example, the hash identifier may be a SHA-256 universal unique identifier (UUID). SHA-256 is a cryptographic hash function that outputs a value that is 256 bits. The output of an SHA-256 algorithm may be the UUID of each layer of docker image 115.

In step 6, second computing service 204 queries database 120 to determine which layers are not present in database 120. Second computing service 204 may compare each layer's hash identifier in database 120 with docker image 115's layers' hash identifiers to determine whether the docker image 115's layers are present in database 120. As such, second computing service 204 may identify one or more layers of docker image 115 not present in database 120.

In step 7, second computing service 204 transmits a message to messaging service 202. The message may include instructions for downloading the one or more layers not present in database 120.

In step 8, messaging service 202 may forward the message to third computing service 208. Third computing service 208 may be part of server 100. Third computing service 208 may be a serverless compute service. Furthermore, third computing service 208 may be an event-driven compute service. An event may be a request, message, an action related to a database (commit, delete, transfer, etc.), a received input, etc. In this scenario, the event may be receiving a message from messaging service 202.

In step 9, the message from messaging service 202 triggers third computing service 208 to retrieve one or more layers of docker image 115 that are missing from database 120 from repository 206. The layers may be downloaded from repository 206. According to some aspects, layers may be downloaded from repository 206 concurrently, in-parallel, and/or the like. Third computing service 208 may extract the constituent files from repository 206 of the one or more layers. When/if the files include a database file, third computing service 208 may use static analysis technology to unpack or expand the list of detected software packages (e.g., software items) in the respective layer. Static analysis technology involves unpacking the list of software packages without executing the software packages or the underlying container. Static analysis technology involves tools to perform one or more of the following types of static analysis:
Unit Analysis: An analysis that takes place within a specific program or subroutine.
Technology Level: Analysis that takes into account interactions between unit programs to get a more holistic and semantic view of the overall program.
System Level: Analysis that takes into account the interactions between unit programs.
Mission/Business Level: Analysis that takes into account the business/mission layer terms, rules, and processes that are implemented within the software system for its operation as part of enterprise or program/mission layer activities.

Third computing service 208 may be configured to implement one or more parsers and/or command-line package management interfaces to parse different types of docker image files. According to some aspects, the one or more parsers and/or command-line package management interfaces may include, but are not limited to, Ubuntu® (e.g., dpkg, apt, etc), Debian®, rpm (yum, dnf, etc.), CentOS®, Red Hat Enterprise Linux® (RHEL), Fedora®, Amazon®, pacman (yay, pacman, pacaur, etc; Arch Linux®), apk (Alpine®), node.js package.j son files, python egg-info files, and/or the like. Third computing service 208 may extract a list of detected software packages from each layer of the one or more layers not present in database 120.

In step 10, third computing service 208 stores the list of detected software packages in each of the respective layers of the one or more layers not present in the database 120. Third computing service 208 may consolidate the detected software packages from each of the one or more layers into a single list. Third computing service 208 may correlate each detected software package with the corresponding layer in database 120.

In some embodiments, the consolidated list of software packages may be transmitted to a given client device configured to generate a report of the software packages deployed in the distributed system. The report may be used for reporting, alerting, compliance, monitoring, or inspecting.

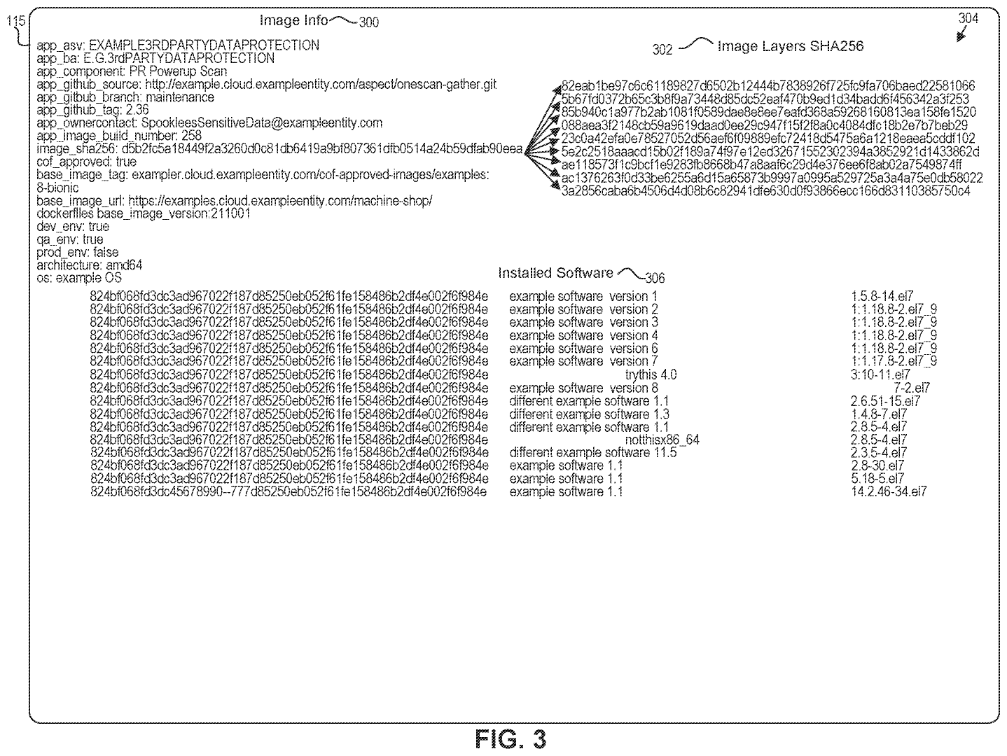

FIG. 3 illustrates an example docker image, according to some embodiments. FIG. 3 shall be described with reference to FIGS. 1-2.

Docker image 115 may include image info 300, layers 302, and a list of software packages 306. Image info 300 may include information about docker image 115. The information may include image identifier, build information, architecture, operating system, etc. The image identifier may be an encrypted hash identifier. For example, the image identifier may be encrypted using a cryptographic hash algorithm such as SHA-256. The build information may be a build number of the applications in docker image 115. The build number may be a version of the applications or docker image. The build information may also include addresses for accessing the code for the applications. The architecture information may include an identifier of a cluster or set of computing devices used to execute the applications. The architecture information may also include identifiers of the production and development environments. The operating system information may include the name of the operations system to execute the applications in docker image 115.

Layers 302 may include an encrypted hash identifier 304 for each layer. Docker image 115 may include multiple layers. Second computing service 204 may compare encrypted hash identifier 304 for each layer 302 with the layers stored in database 120 to determine whether layers 302 are present in docker image 115. Second computing service 204 may determine that one or more of layers 302 are not present in database 120.

Third computing service 208 may download the one or more layers 302 not present in database 120. Third computing service 208 may unpack each of the one or more layers 302 to identify list of software packages 306 corresponding to each respective layer 302.

The list of software packages 306 may comprise encrypted hash identifier 304 of the respective layer 302, software package name, and the software package version. Encrypted hash identifier 304 may use a cryptographic hash algorithm such as SHA-256. For example, if layer 302's is named “abc” the corresponding hash identifier 304 may be “ba7816bf8f01cfea414140de5dae2223b00361a396177a9cb410ff61f20015ad”.

The software package name may be the name of the software to be deployed. For example, the software package name may be: GeoIP.x86_64. The software package version may be the version of the software package to be deployed. For example the software package version may be 1.50-14e17.

Third computing service 208 may consolidate list of software packages 306 for each of the one or more layers 302 and store the consolidated list of software packages 306 in database 120.

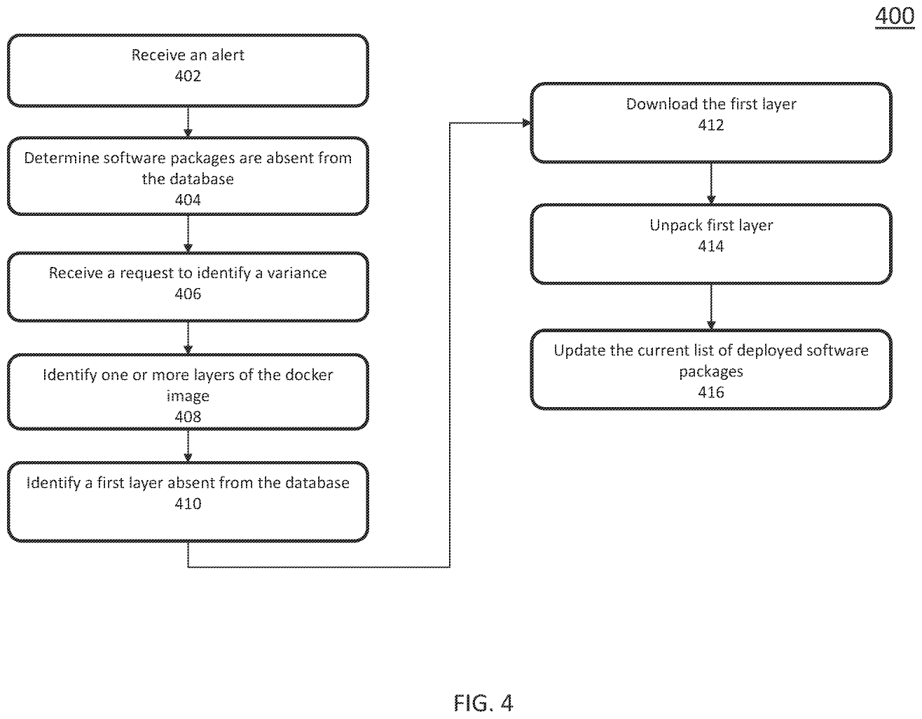

FIG. 4 is a flowchart illustrating the process for identifying the deployed software packages in a distributed system, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously or in a different order than shown in FIG. 4, as will be understood by a person of ordinary skill in the art.

Method 400 shall be described with reference to FIGS. 1 and 2. However, method 400 is not limited to those figures or example embodiments.

In 402, server 100 receives an alert that software packages corresponding to docker image 115 have been deployed in a distributed system. The alert may include docker image 115. First computing service 200 of server 100 may receive the alert. Client device 110 may transmit the alert and docker image 115 to first computing service 200.

In 404, server 100 determines that the software packages are absent from database 120 based on a comparison of the software packages corresponding to docker image 115 to the software packages in database 120. First computing service 200 may be triggered to query database 120 in response to receiving the alert to determine whether the software packages are present in database 120.

In 406, server 100 receives a request to identify a variance between a current list of deployed software pack deployed software packages stored in a database and the software packages associated with the docker image. The current list of deployed software packages indicates a respective layer of a plurality of layers and a respective docker image of each software package in the list. Second computing service 204 of server 100 may receive the request to identify the variance. Second computing service 204 may be triggered to retrieve metadata or manifests corresponding to the docker image from repository 206.

In 408, server 100 identifies one or more layers of docker image 115. The metadata or manifest of docker image 115 may include the layers of docker image 115. Specifically, the metadata or manifest of docker image 115 may comprise an encrypted hash value identifier of each layer of docker image 115. Second computing service 204 may identify the layers from the metadata or manifests of docker image 115.

In 410, server 100 identifies a first layer of the one or more layers of docker image 115 that is absent from database 120. Second computing service 204 compares an encrypted hash identifier of each layer of the one or more layers with the layers stored in database 120 to determine that the first layer of the one or more layers is absent from database 120. For example, an encrypted hash identifier of a layer may be “ba7816bf8fOlcfea414140de5dae2223b00361a396177a9cb410ff61f20015ad.” Second computing service 204 may look for “ba7816bf8fOlcfea414140de5dae2223b00361a396177a9cb410ff61f20015ad” in database 120. If the hash identifier is not present, second computing service 204 may determine that the corresponding layer is not present in database 120.

In 412, server 100 downloads the first layer from repository 206. Second computing service 204 may instruct third computing service 208 of server 100 to download the first layer from repository 206. The first layer may include the corresponding software packages.

In 414, server 100 unpacks the first layer to identify the corresponding software packages corresponding to the first layer. Third computing service 208 may use static analysis technology to expand or unpack the list of software packages in the first layer.

In 416, server 100 updates the current list of deployed software packages stored in database 120 to include software packages included in the first layer. Database 120 may store the current list of deployed software packages correlated with the corresponding layer. The current list of deployed software packages may be used for reporting, alerting, compliance monitoring, and arbitrary introspection by application teams.

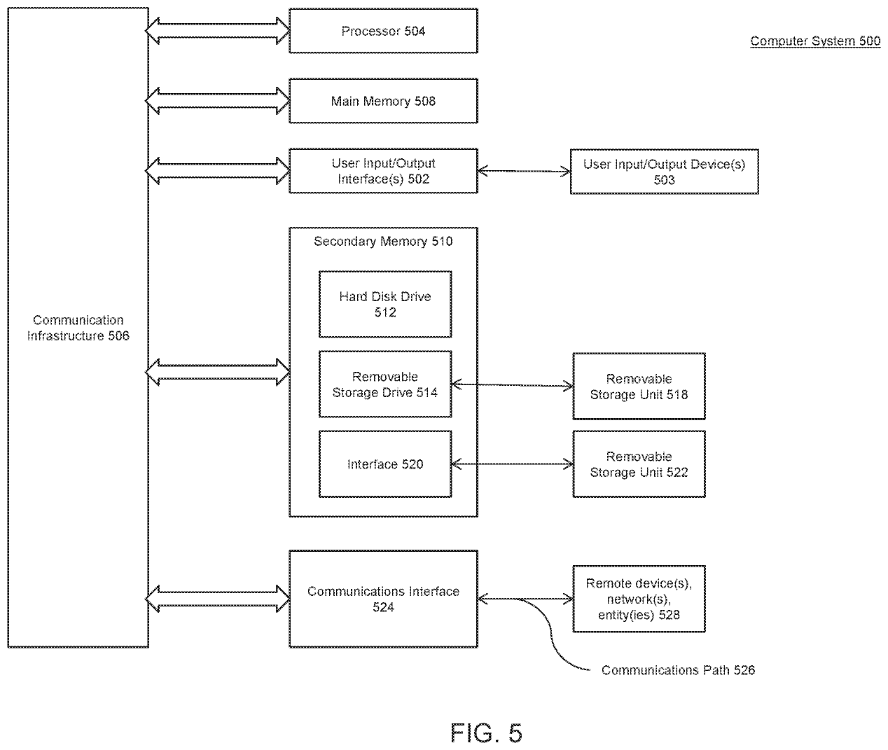

Various embodiments can be implemented, for example, using one or more computer systems, such as computer system 500 shown in FIG. 5. Computer system 500 can be used, for example, to implement the example data flow of FIG. 2 and/or the method 400 of FIG. 4. Furthermore, computer system 500 can be at least part of server 100, client device 110, data storage device 120, and external sources 140, as shown in FIG. 1. For example, computer system 500 route communication to various applications. Computer system 500 can be any computer capable of performing the functions described herein.

Computer system 500 can be any well-known computer capable of performing the functions described herein.

Computer system 500 includes one or more processors (also called central processing units, or CPUs), such as a processor 504. Processor 504 is connected to a communication infrastructure or bus 506.

One or more processors 504 can each be a graphics processing unit (GPU). In an embodiment, a GPU is a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 500 also includes user input/output device(s) 503, such as monitors, keyboards, pointing devices, etc., that communicate with communication infrastructure 506 through user input/output interface(s) 502.

Computer system 500 also includes a main or primary memory 508, such as random access memory (RAM). Main memory 508 can include one or more levels of cache. Main memory 508 has stored therein control logic (i.e., computer software) and/or data.

Computer system 500 can also include one or more secondary storage devices or memory 510. Secondary memory 510 can include, for example, a hard disk drive 512 and/or a removable storage device or drive 514. Removable storage drive 514 can be a floppy disk drive, a magnetic tape drive, a compact disk drive, an optical storage device, tape backup device, and/or any other storage device/drive.

Removable storage drive 514 can interact with a removable storage unit 518. Removable storage unit 518 includes a computer usable or readable storage device having stored thereon computer software (control logic) and/or data. Removable storage unit 518 can be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 can include other means, instrumentalities, or other approaches for allowing computer programs and/or other instructions and/or data to be accessed by computer system 500. Such means, instrumentalities, or other approaches can include, for example, a removable storage unit 522 and an interface 520. Examples of the removable storage unit 522 and the interface 520 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 can further include a communication or network interface 524. Communication interface 524 enables computer system 500 to communicate and interact with any combination of remote devices, remote networks, remote entities, etc. (individually and collectively referenced by reference number 528). For example, communication interface 524 can allow computer system 500 to communicate with remote devices 528 over communications path 526, which can be wired and/or wireless, and which can include any combination of LANs, WANs, the Internet, etc. Control logic and/or data can be transmitted to and from computer system 500 via communication path 526.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other but yet still co-operate or interact with each other.

The breadth and scope of this disclosure should not be limited by any of the above-described exemplary embodiments, but should be defined only in accordance with the following claims and their equivalents.

What is claimed is:

1. A method for identifying deployed software packages, the method comprising:
receiving, by a processor, a request to identify a variance between a current list of deployed software packages stored in a database and a plurality of software packages associated with a docker image, wherein the current list of deployed software packages indicates a respective layer of a plurality of layers and a respective docker image of a plurality of docker images of each software package in the list;
identifying, by the processor, one or more layers of the docker image based on metadata of the docker image;
identifying, by the processor, a first layer of the one or more layers that is absent from the database;
downloading, by the processor, the first layer;
unpacking, by the processor, the first layer to identify a first set of software packages from the plurality of software packages corresponding to the first layer; and
updating, by the processor, the current list of deployed software packages in the database to include the first set of software packages.

2. The method of claim 1, wherein the identifying of the first layer of the one or more layers that is absent from the database comprises comparing, by the processor, an identifier of each layer of the one or more layers with the plurality of layers in the current list of deployed software packages.

3. The method of claim 1, wherein the identifier of each layer is an output of a hash function.

4. The method of claim 1, further comprising:
receiving, by the processor, an alert that the plurality of software packages corresponding to the docker image have been deployed; and
determining, by the processor, that the plurality of software packages are absent in the database.

5. The method of claim 1, further comprising:
identifying, by the processor, a second layer from the one or more layers that is absent from the database;
unpacking, by the processor, the second layer to identify a second set of software packages from the plurality of software packages corresponding to the second layer;
generating, by the processor, a consolidated list of the first and second set of software packages; and
updating, by the processor, the current list of deployed software packages to include the consolidated list of the first and second set of software packages.

6. The method of claim 1, wherein identifying the first set of software packages comprises identifying the first set of software packages when the docker image is stateless.

7. The method of claim 1, wherein the first layer and the metadata of the docker image are stored in a registry.

8. A system for identifying deployed software packages, the system comprising:
a processor coupled to a memory, the processor is configured to:
receive a request to identify a variance between a current list of deployed software packages stored in a database and a plurality of software packages associated with a docker image, wherein the current list of deployed software packages indicates a respective layer of a plurality of layers and a respective docker image of a plurality of docker images of each software package in the list;
identify one or more layers of the docker image based on a metadata of the docker image;
identify a first layer of the one or more layers that is absent from the database;
download the first layer;
unpack the first layer to identify a first set of software packages from the plurality of software packages corresponding to the first layer; and
update the current list of deployed software packages in the database to include the first set of software packages.

9. The system of claim 8, wherein the processor configured to identify the first layer of the one or more layers that is absent from the database is further configured to compare an identifier of each layer of the one or more layers with the plurality of layers in the current list of deployed software packages.

10. The system of claim 9, wherein the identifier of each layer is an output of a hash function.

11. The system of claim 8, wherein the processor is further configured to:
receive an alert that the plurality of software packages corresponding to the docker image have been deployed; and
determine that the plurality of software packages are absent in the database.

12. The system of claim 8, wherein the processor is further configured to:
identify a second layer from the one or more layers that is absent from the database;
unpack the second layer to identify a second set of software packages from the plurality of software packages corresponding to the second layer;
generate a consolidated list of the first and second set of software packages; and
update the current list of deployed software packages to include the consolidated list of the first and second set of software packages.

13. The system of claim 8, wherein identifying the first set of software packages comprises identifying the first set of software packages when the docker image is stateless.

14. The system of claim 8, wherein the first layer and the metadata of the docker image are stored in a registry.

15. A non-transitory computer-readable medium having instructions stored thereon that, when executed by at least one computing device, cause the at least one computing device to perform operations comprising:
receiving a request to identify a variance between a current list of deployed software packages stored in a database and a plurality of software packages associated with a docker image, wherein the current list of deployed software packages indicates a respective layer of a plurality of layers and a respective docker image of a plurality of docker images of each software package in the list;
identifying one or more layers of the docker image based on a metadata of the docker image;
identifying a first layer of the one or more layers that is absent from the database;
downloading the first layer;
unpacking the first layer to identify a first set of software packages from the plurality of software packages corresponding to the first layer; and
updating the current list of deployed software packages to include the first set of software packages.

16. The non-transitory computer-readable medium of claim 15, wherein the identifying of the first layer of the one or more layers that is absent from the database comprises comparing an identifier of each layer of the one or more layers with the plurality of layers in the current list of deployed software packages.

17. The non-transitory computer-readable medium of claim 16, wherein the identifier of each layer is an output of a hash function.

18. The non-transitory computer-readable medium of claim 15, wherein the operations further comprise:
receiving an alert that the plurality of software packages corresponding to the docker image have been deployed; and
determining that the plurality of software packages are absent in the database.

19. The non-transitory computer-readable medium of claim 15, wherein the operations further comprise:
identifying a second layer from the one or more layers that is absent from the database;
unpacking the second layer to identify a second set of software packages from the plurality of software packages corresponding to the second layer;
generating a consolidated list of the first and second set of software packages; and
updating the current list of deployed software packages to include the consolidated list of the first and second set of software packages.

20. The non-transitory computer-readable medium of claim 15, wherein identifying the first set of software packages comprises identifying the first set of software packages when the docker image is stateless.
